(19) United States
(12) Patent Application Publication
(10) Pub. No.: US 2013/0223273 A1
(43) Pub. Date: Aug. 29, 2013

(54) METHOD AND APPARATUS FOR EVALUATING AN AIR INTERFACE CONDITION OF A WLAN

(71) Applicants: Xiangqing Chang, Beijing (CN); Yujin Zhao, Beijing (CN); Hongfei Zhang, Beijing (CN); Haitao Zhang, Beijing (CN); Jianfeng Liu, Beijing (CN)

(72) Inventors: Xiangqing Chang, Beijing (CN); Yujin Zhao, Beijing (CN); Hongfei Zhang, Beijing (CN); Haitao Zhang, Beijing (CN); Jianfeng Liu, Beijing (CN)

(73) Assignee: HANGZHOU H3C TECHNOLOGIES CO,.LTD., Hangzhou (CN)

(21) Appl. No.: 13/884,563

(22) PCT Filed: Oct. 21, 2011
(86) PCT No.: PCT/CN11/81124

§ 371 Date: May 9, 2013

(30) Foreign Application Priority Data
Nov. 18, 2010 (CN) 201010552369.5

(51) Int. Cl. H04W 24/00

(52) U.S. Cl. CPC H04W 24/00
USPC 370/252

(57) ABSTRACT

In a method and an apparatus for evaluating air interface condition of a wireless local area network (WLAN), the evaluation of the air interface condition of the WLAN is divided into four layers: the evaluation of the air interface condition of the pre-defined area, the evaluation of the air interface condition of each place in the pre-defined area, the evaluation of the air interface condition of each AP in each place and the evaluation of the air interface condition of each user accessing each AP. The method and apparatus are able to provide definite evaluation denoting the level of the air interface condition through analyzing and quantizing of the statistical information items with respect to the overall air interface condition of the whole area covered by the WLAN or the partial air interface condition of each place, each AP and each user in the pre-defined area.

### FIELD

The present disclosure relates to wireless network evaluating techniques, and more particularly, to a method and apparatus for evaluating an air interface condition of a Wireless Local Area Network (WLAN).

### BACKGROUND

WLAN is a type of wireless local area network. A typical networking structure is as shown in FIG. 1. The typical networking structure is depicted as including the following WLAN apparatuses: Access Controller (AC), Access Point (AP) and Station (STA). Generally, the AC is arranged in a special network computer room and is to manage and control the AP under the AC. The AP is generally positioned near users of the STA, for instance, a dormitory, office building and various other places. The AP mainly operates to exchange air interface packets with the STA.

Generally, the STA in the WLAN visits the air interface in a Carrier Sense Multi-Access/Collision Avoidance (CSMA/CA) manner, that is, all the STAs in the WLAN share the air interface medium. Therefore, the air interface condition of the WLAN actually varies dynamically with the number of STA users, detailed applications of the users and other interfering situations.

Just like the traffic on a city road, which is at peak conditions during rush hours when there are many vehicles on the road, and which is at an idle condition during non-rush hours. However, the condition of the road CaO be seen from cameras, whereas the air interface condition of the WLAN is invisible.

### SUMMARY

Examples of the present disclosure provide a method and an apparatus for evaluating an air interface condition of a Wireless Local Area Network (WLAN), so as to optimize the evaluation of the air interface condition of WLAN.

According to one example of the present disclosure, a method for evaluating the air interface condition of a WLAN is provided. The method includes:

collecting statistical information items that reflect the air interface condition of the WLAN;

collecting statistics according to the statistical information items to obtain quantification values of the air interface condition of a pre-defined area, quantification values of the air interface condition of each place in the pre-defined area, quantification values of the air interface condition of each Access Point (AP) in each place, and quantification values of the air interface condition of each user accessing each AP;

respectively comparing the quantification values of the air interface condition of the pre-defined area, the quantification values of the air interface condition of each place, the quantification values of the air interface condition of each AP and the quantification values of the air interface condition of each user with corresponding thresholds, and obtaining evaluated results respectively denoting a level of the air interface condition of the pre-defined area, a level of the air interface condition of each place, a level of the air interface condition of each AP and a level of the air interface condition of each user.

According to another example of the present disclosure, an apparatus for evaluating the air interface condition of a WLAN is provided. The apparatus includes a memory and a processor in communication with the memory, the memory including computer code executable with the processor, wherein the computer code is:

to collect statistical information items that reflect the air interface condition of the WLAN;

to collect statistics according to the statistical information items to obtain quantification values of the air interface condition of a pre-defined area, to obtain quantification values of the air interface condition of each place in the pre-defined area, to obtain quantification values of the air interface condition of each Access Point (AP) in each place, and to obtain quantification values of the air interface condition of each user accessing each AP;

respectively compare the quantification values of the air interface condition of the pre-defined area, the quantification values of the air interface condition of each place, the quantification values of the air interface condition of each AP and the quantification values of the air interface condition of each user with corresponding thresholds, and obtain evaluated results respectively denoting a level of the air interface condition of the pre-defined area, a level of the air interface condition of each place, a level of the air interface condition of each AP and a level of the air interface condition of each user.

### BRIEF DESCRIPTION OF THE DRAWINGS

FIG. 1 is a schematic diagram illustrating a typical networking structure of a WLAN.

FIG. 2 is a schematic diagram illustrating a type of architecture for realizing the evaluation the air interface condition of the WLAN according to an example of the present disclosure.

FIG. 3 is a schematic diagram illustrating the evaluation of the air interface condition of the AP according to an example of the present disclosure.

FIG. 4 is a schematic diagram illustrating the evaluation of the air interface condition of the user according to an example of the present disclosure.

FIG. 5 is a schematic diagram illustrating a structure of an apparatus for evaluating the air interface condition according to an example of the present disclosure.

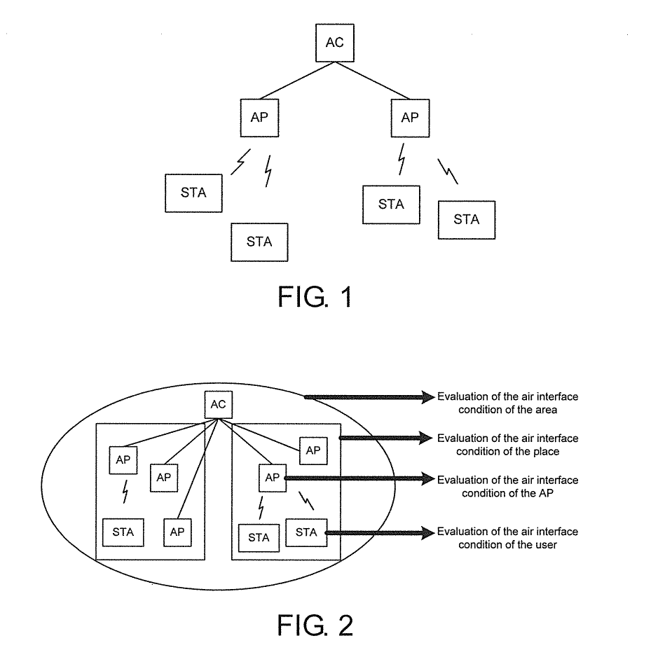

### DETAILED DESCRIPTION

In order to acquire the invisible air interface condition of the WLAN, the display of an air interface spectrum information of a special location by a professional radio frequency spectrum analyzing tool has been attempted. But the air interface spectrum information that the radio frequency spectrum analyzing tool can display is merely local information of the special location, and thus cannot reflect the overall air interface condition of the WLAN. Moreover, what is displayed by the radio frequency spectrum analyzing tool is merely some radio frequency spectrum information. No data analyzing or integration is provided, not to mention definite evaluation of the air interface condition.

In addition, attempts have been made to obtain connection data of the STA through layer-2 connection actions such as PING and to determine the air interface condition of the STA according to the connection data obtained. Similar to the above method, the connection data with respect to one STA cannot reflect the overall air interface condition of the WLAN. And the connection data is merely air interface data for reference. No data analyzing or integration is provided either, not to mention the definite evaluation of the air interface condition.

Examples of the present disclosure are able to optimize the evaluation of the air interface condition of the WLAN. The examples of the present disclosure provide definite evaluation through data analyzing and integration.

Although the evaluation of the air interface condition is related to a certain area covered by the WLAN, this does not mean that the evaluation focuses on only the overall evaluation of the area covered by the WLAN.

Considering that the area covered by the WLAN to be evaluated may include a plurality of places with different air interface conditions, each place may further have a plurality of APs with different air interface conditions, and users accessing to the same AP may also have different air interface conditions. Examples of the present disclosure divide the evaluation of the air interface condition of the WLAN into 4 layers, as shown in FIG. 2 (FIG. 2 shows only one AC, the ellipse denotes area, the rectangle where the AP resides denotes the place), the evaluation of the overall air interface condition in the area, the evaluation of the air interface condition of each place in the area, the evaluation of the air interface condition of each AP in the place, and the evaluation of the air interface condition of each user accessing the AP. The evaluations of the layers may be independent from each other, that is, the evaluated result is irrelevant to the evaluation time. Certainly, if it is required, it is also possible to configure the evaluated result of each layer to be associated with the evaluation time.

The evaluation of the overall air interface condition of the area mainly focuses on the AC. In practical applications, the area may be a geographical area such as a campus or an industry park, or, the area may also be a logical area defined in any manner. There may be only one AC or a plurality of ACs in the area.

The evaluation of the air interface condition of each place mainly focuses on a group of APs in the place. In practical applications, the place in the area may be a physical space such as a building or a stadium. Or, the place may also be a logical space defined in any manner (e.g., spaces with similar wireless circumstance, and/or similar position, and/or interfering air interfaces). The number of APs in the group may be one or more.

The evaluation of the air interface condition of the AP focuses on a single AP. In practical applications, the number of users accessing each AP may be one or more.

The evaluation of the air interface condition of the user disclosed herein focuses on a single user.

As such, whether what is concerned is the overall air interface condition of the area covered by the WLAN or the partial air interface condition of each place, each AP and each user in the area, examples of the present disclosure are able to provide definite evaluation and provide the evaluation to a network management device. Thus, a manager may learn the overall or partial air interface condition of the WLAN at a glance.

Hereinafter, the method and apparatus for evaluating the air interface condition will be described in detail with reference to examples based on the above architecture.

In the method for evaluating the air interface condition of this example, statistical information items for reflecting the air interface condition of the WLAN are to initially be collected.

The statistical information items are mainly obtained from information carried in air interface packets reported by the AP to the AC. For example, each AP in the area reports its air interface packets to the AC to which it belongs. Thus, the collection of the statistical information items may be completed by aggregating the air interface packets or information carried by the air interface packets received by the AC; alternatively, it is also possible to collect an evaluated result of certain layers as the statistical information item of another layer.

Then, with respect to the evaluation of the overall air interface condition of the area, statistics according to the statistical information items reported by all the APs in the area are collected to obtain quantification values of the air interface condition of the area. With respect to the evaluation of the air interface condition of the place, statistics according to the statistical information items reported by all the APs in the place are collected to obtain quantification values of the air interface condition of the place. With respect to the evaluation of the air interface condition of a single AP, statistics according to the statistical information items reported by the AP are collected to obtain quantification values of the air interface condition of the AP. With respect to the evaluation of the air interface condition of a single user, statistics according to the statistical information items related with the user reported by the AP where the user belongs are collected to obtain quantification values of the air interface condition of the user.

In practical applications, it is possible to configure an AP set in the area and an AP set in the place in advance. Since each AP reports the statistical information items through air interface packets and the air interface packets carry identity information uniquely identifying the AP, it is possible to determine from which AP a reported statistical information item was collected through a comparison of the identity information in the air interface packet with the AP sets. In addition, the place and the area from which the reported statistical information item was collected may also be determined through the comparison.

Finally, with respect to the evaluation of the overall air interface condition, the quantification values of the air interface condition of the area are compared with thresholds denoting different levels of the air interface condition of the area to obtain an evaluated result about the level of the air interface condition of the area. With respect to the evaluation of the air interface condition of the place, the quantification values of the air interface condition of the place are compared with thresholds denoting different levels of the air interface condition of the place to obtain an evaluated result of the level of the air interface condition of the place. With respect to the evaluation of the air interface condition of the single AP, the quantification values of the air interface condition of the single AP are compared with thresholds denoting different levels of the air interface condition of the AP to obtain an evaluated result of the level of the air interface condition of the AP. With respect to the evaluation of the air interface condition of a single user, the quantification values of the air interface condition of the single user are compared with thresholds denoting different levels of the air interface condition of the user to obtain an evaluated result of the level of the air interface condition of the user.

The above comparisons with the thresholds may also be seen as comparisons of the quantification values with different threshold ranges of different air interface condition levels.

Certainly, as to the 4 evaluation layers, i.e., the evaluation of the overall air interface condition of the area, the evaluation of the air interface condition of the place, the evaluation of the air interface condition of the AP and the evaluation of the air interface condition of the user, the statistical information items used for collecting the air interface condition quantification values and the detailed collecting methods may be different to some extent.

Hereinafter, the evaluation of each layer will be described in detail.

1) regarding the evaluation of the overall air interface condition of the area:
1.1) the statistical information items used:

a total air interface throughput of all the APs under all the ACs in the area;

the number of normal-operating APs (which is powered-on, has no abnormal damage and has at least one user accessed) in the area; and

the number of users accessed to normal-operating APs under all the ACs in the area.

According to an example, the above statistical information items are collected during a pre-defined evaluation time period, generally 5-20 min during peak usage hours. If the selected evaluation period is relatively long, there may be some users that become online or offline within the evaluation period. In order to reduce error, it is possible to obtain the number of users at the beginning of the evaluation period and obtain the number of users again at the end of the evaluation period, and take an average value of the two numbers as the number of users of the statistical information items.
1.2) The air interface condition quantification values of the area and their collection manners:

an average air interface throughput for each AP under all the ACs of the area, obtained through dividing the total air interface throughput of all the APs under all the ACs of the area by the number of normal-operating APs in the area.

an average air interface throughput for each user, obtained by dividing the total air interface throughput of all the APs under all the ACs of the area by the number of users in the statistical information items.

Certainly, other statistical information may be added into the above statistical information items, or may be used to replace the above statistical information items. Accordingly, the above air interface condition quantification values may be quantification values of other types or may be obtained through other manners.
1.3) An evaluated result representing a level of the air interface condition of the area:

If the average air interface throughput for each AP in the area is larger than or equal to 5M, and the average air interface throughput for each user is larger than or equal to 0.4M, the evaluated result represents the level of the air interface condition of the area as “excellent”.

If the average air interface throughput for each AP in the area is larger than or equal to 3M, and the average air interface throughput for each user is not limited, the evaluated result represents the level of the air interface condition of the area as “good”.

If the average air interface throughput for each AP in the area is larger than or equal to 1M but smaller than 3M, and the average air interface throughput for each user is not limited, the evaluated result represents the level of the air interface condition of the area as “medium”.

If the average air interface throughput for each AP in the area is smaller than 1M, and the average air interface throughput for each user is not limited, the evaluated result represents the level of the air interface condition of the area as “poor”.

The details are as shown in table 1.

TABLE 1

| | excellent | good | medium | poor |
|---|---|---|---|---|
| Average air interface throughput | ≧5M | ≧3M | ≧1M | <1M |
| for each AP | | | | |
| Average air interface throughput | ≧0.4M | no limit | no limit | no limit |
| for each user | | | | |

Certainly, the above thresholds, such as 5M, 3M, 1M, used for evaluating the levels of the air interface condition of the area are merely example values. In practical applications, those with ordinary skill in the art may configure the thresholds of the levels for evaluating the air interface condition of the area according to experience or expect. The levels may also be set by those with ordinary skill in the art according to at least one requirement.

2) Regarding the evaluation of the air interface condition of the place:
2.1) the statistical information items use a total air interface throughput of all the APs in the place;

the number of normal-operating APs (which is powered-on, has no abnormal damage, and has at least one user accessed);

packet transmission rate statistical data of each AP in the place; and

packet receiving rate statistical data of each AP in the place.

According to an example, the above statistical information items are collected within a pre-defined evaluation time period, for instance, 5-20 min during peak usage hours.
2.2) the quantification values of the air interface condition of the place and their collection manners:

an average air interface throughput for each AP in the place, obtained by dividing the total air interface throughput of all the APs in the place by the number of normal-operating APs in the place;

an average packet high rate transmission ratio in the place, obtained by calculating a packet high rate transmission ratio of each AP according to the packet transmission rate statistical data of the AP in the place (the detailed calculating manner may be implemented by those with ordinary skill in the art) and dividing a sum of packet high rate transmission ratios of all the APs by the number of normal-operating APs in the place;

an average packet high rate receiving ratio in the place, obtained by calculating a packet high rate receiving ratio of each AP according to the packet receiving rate statistical data of the AP in the place (the detailed calculating manner may be implemented by those with ordinary skill in the art) and dividing a sum of packet high rate receiving ratios of all the APs by the number of normal-operating APs in the place.

Certainly, other statistical information may be added into the above statistical information items, or may be used for replace the above statistical information items. Accordingly, the above air interface condition quantification values may be quantification values of other types or may be obtained through other manners.
2.3) An evaluated result representing the level of the air interface condition of the place:

If the average air interface throughput for each AP in the place is larger than or equal to 5M, the average packet high rate transmission ratio of the place is higher than or equal to 90%, and the average packet high rate receiving ratio of the place is higher than or equal to 85%, the evaluated result represents the level of the air interface condition of the place as “excellent”.

If the average air interface throughput for each AP in the place is larger than or equal to 4M, the average packet high rate transmission ratio of the place is higher than or equal to 85%, and the average packet high rate receiving ratio of the place is higher than or equal to 80%, the evaluated result represents the level of the air interface condition of the place as “good”.

If the average air interface throughput for each AP in the place is larger than or equal to 3M, the average packet high rate transmission ratio of the place is higher than or equal to 80%, and the average packet high rate receiving ratio of the place is higher than or equal to 65%, the evaluated result represents the level of the air interface condition of the place as “medium”.

If the average air interface throughput for each AP in the place is smaller than 3M, the average packet high rate transmission ratio of the place is lower than 80%, and the average packet high rate receiving ratio of the place is lower than 65%, the evaluated result represents the level of the air interface condition of the place as “poor”.

The details are as shown in table 2.

TABLE 2

| | Excellent | Good | medium | poor |
|---|---|---|---|---|
| Average air interface throughput | ≧5M | ≧4M | ≧3M | <3M |
| for each AP | | | | |
| Average packet high rate | ≧90% | ≧85% | ≧80% | <80% |
| transmission ratio | | | | |
| Average packet high rate | ≧85% | ≧80% | ≧65% | <65% |
| receiving ratio | | | | |

Certainly, the above thresholds, such as 5M, 3M, 1M, 90%, 80%, used for evaluating the levels of the air interface condition of the place are merely example values. In practical applications, those with ordinary skill in the art may configure the thresholds of the levels for evaluating the air interface condition of the place according to experience or expect. The levels may also be set by those with ordinary skill in the art according to at least one requirement.

3) Regarding the evaluation of the air interface condition of the AP:

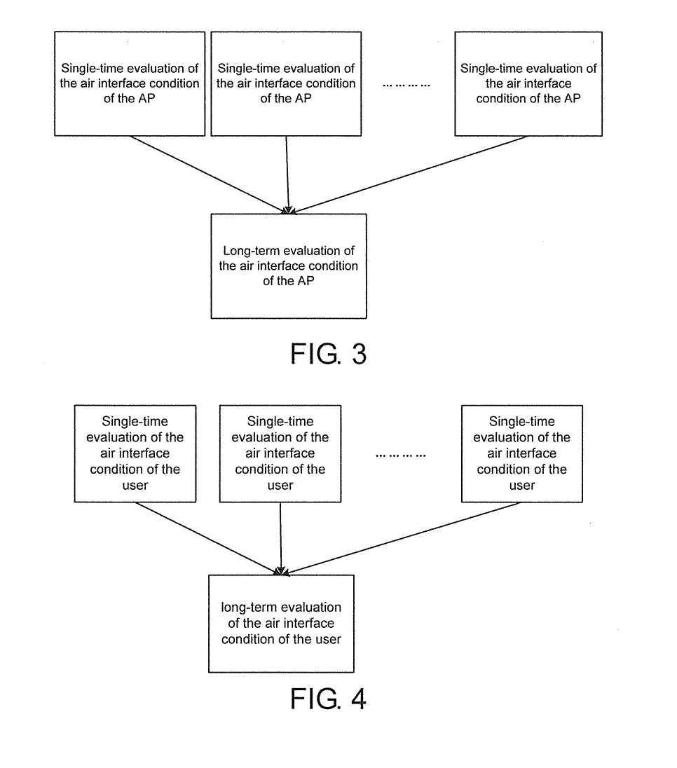

The air interface condition of a single AP may change dynamically with the number of users accessing the AP, the applications of the users and interferences. In other words, the air interface condition of some APs may be very stable, whereas others may be very instable. Therefore, the evaluation of the air interface condition of the AP will not be very accurate on basis of a single-time evaluation. As such, examples of the present disclosure evaluate the air interface condition of the AP in two phases, as shown in FIG. 3, the first phase is a single-time evaluation based on statistical information items, and the second phase is a long-term evaluation based on single-time evaluated results.

It should be noted that, one area or one place usually has a plurality of APs. Therefore, the APs in the same area or the same place may have different dynamic changes. The different dynamic changes may compensate for each other to reduce the dynamic changes of the air interface condition of the same area or the same place. Therefore, the evaluation of the air interface condition of the area and that of the place may not heavily rely on the two-phased evaluation.
3.1) statistical information items used for the single-time evaluation stage:

air interface throughput of the AP;

packet transmission loss statistical data of the AP;

packet transmission rate statistical data of the AP;

packet receiving error statistical data of the AP;

packet receiving rate statistical data of the AP; and

the number of users accessing the AP.

In addition, the number of “poor” users with respect to evaluation of air interface condition of the users may also be taken as a statistical information item of the single-time evaluation phase (for more information about the definition of “poor” user, please refer to the description of the evaluation of the air interface condition of the user below).

The above statistical information items are collected within the pre-defined evaluation time period generally 5-20 min during peak usage hours.
3.2) quantification values of the air interface condition at the single-time evaluation phase and their collection manners:

average air interface throughput for each user accessing the AP, obtained through dividing the air interface throughput of the AP by the number of users accessing the AP;

packet transmission loss ratio of the AP, obtained according to the packet transmission loss statistical data of the AP (the detailed calculation method may be implemented by those with ordinary skill in the art);

packet high rate transmission ratio of the AP, obtained according to the packet transmission rate statistical data of the AP (the detailed calculation method may be implemented by those with ordinary skill in the art);

packet receiving error ratio of the AP, calculated according to the packet receiving error statistical data of the AP (the detailed calculation method may be implemented by those with ordinary skill in the art); and

packet high rate receiving ratio of the AP, calculated according to the packet receiving rate statistical data of the AP (the detailed calculation method may be implemented by those with ordinary skill in the art).

Optionally, if the number of “poor” users obtained with respect to the evaluation of air interface condition of the user is also taken as the statistical information item for the single-time evaluation phase, the quantification values of the air interface condition at the single-time evaluation phase may further include a proportion of “poor” users which may be obtained by diving the number of “poor” users by the number of users accessing the AP.

Certainly, other statistical information may be added into the above statistical information items, or may be used to replace the above statistical information items. Accordingly, the above air interface condition quantification values may be quantification values of other types or may be obtained through other manners.
3.3) the evaluated result representing the level of the air interface condition of the AP:

If the average air interface throughput for each user of the AP is larger than or equal to 0.2M, the packet transmission loss ratio is lower than 5%, the packet high rate transmission ratio is higher than or equal to 90%, the packet receiving error ratio is lower than 10%, the packet high rate receiving ratio is higher than or equal to 85%, the proportion of “poor” users is lower than 20%, the evaluated result represents the level of the air interface condition of the AP as “excellent”.

If the packet transmission loss ratio is lower than 10%, the packet high rate transmission ratio is higher than or equal to 80%, the packet receiving error ratio is lower than 15%, the packet high rate receiving ratio is higher than or equal to 70%, the proportion of “poor” users is lower than 30%, the evaluated result represents the level of the air interface condition of the AP as “good”.

If the packet transmission loss ratio is lower than 10%, the packet high rate transmission ratio is higher than or equal to 70%, the packet receiving error ratio is lower than 20%, the packet high rate receiving ratio is higher than or equal to 60%, the evaluated result represents the level of the air interface condition of the AP as “medium”.

If the packet high rate transmission ratio is lower than 70%, the evaluated result represents the level of the air interface condition of the AP as “poor”.

The details are as shown in the following table 3a.

TABLE 3a

| | excellent | good | medium | poor |
|---|---|---|---|---|
| average air interface throughput | ≧0.2M | no limit | no limit | no limit |
| for each user of the AP | | | | |
| packet transmission loss ratio | <5% | <10% | <10% | no limit |
| packet high rate transmission | ≧90% | ≧80% | ≧70% | <70% |
| ratio | | | | |
| packet receiving error ratio | <10% | <15% | <20% | no limit |
| packet high rate receiving ratio | ≧85% | ≧70% | ≧60% | no limit |
| proportion of “poor” users | <20% | <30% | no limit | no limit |

Certainly, the above thresholds, such as 0.2M, 90%, 10%, used for evaluating the levels of the air interface condition of the AP at the single-time phase are merely example values. In practical applications, those with ordinary skill in the art may configure the thresholds of the levels for evaluating the air interface condition of the AP at the single-time phase according to experience or expect. The levels may also be set by those with ordinary skill in the art according to at least one requirement.
3.4) the long-term evaluation phase:

As described above, the air interface condition of a single AP tends to change dynamically with the number of users accessing the AP, the applications of the users and interferences (affected by throughput of neighbor APs). Therefore, an accurate final evaluation may be based on consecutive single-time evaluated results within certain observation period (e.g. one or two weeks) to reflect the circumstance condition and the performance of the AP.

Specifically, the long-term evaluation mainly collects balanced statistics according to the levels of air interface condition obtained by the single-time evaluation and obtains a long-term evaluated result according to the balanced statistics. In other words, the levels of the air interface condition obtained by the single-time evaluations are taken as samples, stochastic error in the single-time evaluated results and/or factors resulting in inaccuracy of the single-time evaluated results are eliminated through collecting probability statistics of the samples. Some long-term evaluation instances obtained by collecting experimental data statistics are as shown in table 3b.

TABLE 3b

| Evaluated | | Evaluation | |
|---|---|---|---|
| e level | Sub-level | index | Additional index |
| Good and | Incline to | Proportion of | Proportion of “excellent” > |
| above | excellent | “excellent” and | proportion of “good” |
| | Incline to | “good” > 50% | Proportion of “excellent” < |
| | good | | proportion of “good” |
| Medium | Medium to | Proportion of | Proportion of “poor” < 50% |
| and | good | “medium” and | |
| below | Medium | “poor” > 50% | There are high throughput |
| | due to high | | users and the proportion of the |
| | throughput | | high throughput users > 50% |
| | Medium to | | Proportion of “poor” > 70% |
| | poor | | |
| | medium | | Not satisfy other three |
| | | | sub-levels |
| Change | | Not satisfy the | |
| randomly | | above two | |
| | | sub-levels | |

Certainly, the above thresholds, such as 50%, 70%, used for evaluating the levels of the air interface condition of the AP in the long-term are merely example values. In practical applications, those with ordinary skill in the art may configure the thresholds of the levels for evaluating the air interface condition of the AP in the long-term according to experience or expect. The levels may also be set by those with ordinary skill in the art according to at least one requirement.

4) Regarding the evaluation of the air interface condition of the user:

The air interface condition of a single user may change dynamically with the number of users accessing the same AP, the air interface throughput of other users and the applications of the users. In other words, the air interface condition of some users may be very stable, whereas others may be very unstable. Therefore, the evaluation of the air interface condition of the user may not be very accurate on basis of a single-time evaluation. As such, similar to the evaluation of the air interface of the AP, examples of the present disclosure evaluate the air interface condition of the user in two phases, as shown in FIG. 4, the first phase is a single-time evaluation based on statistical information items, and the second phase is a long-term evaluation based on single-time evaluated results.
4.1) statistical information items used for the single-time evaluation phase:

air interface throughput of the user;

packet loss statistical data of packets transmitted to the user by the AP;

packet transmission rate statistical data of packets transmitted to the user by the AP;

packet receiving rate statistical data of packets received by the AP from the user; and

signal to noise ratio of the user.

The above statistical information items are collected within a pre-defined evaluation time period, generally 5-20 min during peak usage hours.
4.2) quantification values of the air interface condition at the single-time evaluation phase and their collection manners.

air interface throughput of the user;

packet loss ratio of packets transmitted by the AP to the user, which may be calculated according to the packet transmission loss statistical data of packets transmitted to the user by the AP (the detailed calculating method may be selected by those with ordinary skill in the art randomly);

packet high rate transmitting ratio of packets transmitted by the AP to the user, which may be calculated according to the packet transmission rate statistical data of packets transmitted by the AP to the user (the detailed calculating method may be selected by those with ordinary skill in the art randomly); and

packet high rate receiving ratio of packets received by the AP from the user, which may be calculated according to the packet receiving rate statistical data of packets received by the AP from the user (the detailed calculating method may be selected by those with ordinary skill in the art randomly).

Certainly, other statistical information may be added into the above statistical information items, or may be used for replace the above statistical information items. Accordingly, the above air interface condition quantification values may be quantification values of other types or may be obtained through other manners.
4.3) evaluated results representing the levels of the air interface condition of the user:

If the air interface throughput of the user is larger than or equal to 0.2M, packet loss ratio is lower than 1%, the packet high rate transmission ratio is higher than or equal to 90%, the packet high rate receiving ratio is higher than or equal to 85%, the signal to noise ratio is higher than 20%, the evaluated result expresses the level denoting the air interface condition of the user as “excellent”.

If the packet loss ratio of the user is within 1%-3%, the packet high rate transmission ratio is higher than or equal to 80%, the packet high rate receiving ratio is higher than or equal to 70%, the evaluated result expresses the level denoting the air interface condition of the user as “good”.

If the packet loss ratio of the user is within 3%-5%, the packet high rate transmission ratio is higher than or equal to 70%, the packet high rate receiving ratio is higher than or equal to 60%, the evaluated result expresses the level denoting the air interface condition of the user as “medium”.

If the packet loss ratio of the user is higher than 5%, the packet high rate transmission ratio is lower than 60%, the packet high rate receiving ratio is higher than or equal to 50%, the evaluated result expresses the level denoting the air interface condition of the user as “poor”.

TABLE 4a

| | excellent | Good | medium | poor |
|---|---|---|---|---|
| Air interface throughput of the | ≧0.2M | no limit | no limit | no limit |
| user | | | | |
| Packet loss ratio | <1% | 1%~3% | 3%~5% | >5% |
| Average high packet | ≧90% | ≧80% | ≧70% | <60% |
| transmission rate ratio | | | | |
| Average high packet receiving | ≧85% | ≧70% | ≧60% | ≧50% |
| rate ratio | | | | |
| Signal to noise ratio | >20 | no limit | no limit | no limit |

Certainly, the above thresholds, such as 0.2M, 90%, 20, used for evaluating the levels of the air interface condition of the user in the single-time evaluation phase are merely example values. In practical applications, those with ordinary skill in the art may configure the thresholds of the levels for evaluating the air interface condition of the user in the single-time evaluation phase according to experience or expect. The levels may also be set by those with ordinary skill in the art according to at least one requirement.
4.4) long-term evaluation phase

As described above, it is possible to provide a final evaluated result based on consecutive single-time evaluated results within certain observation period (e.g. 1-2 weeks) to reflect the circumstance and the performance of the air interface of the user.

Similar to the long-term evaluation of the air interface of the AP, the long-term evaluation of the air interface of the user is obtained based on balanced statistics of single-time evaluated results denoting levels of the air interface condition of the user. That is to say, the levels denoting the air interface condition of the user expressed by the single-time evaluated results are taken as samples, and random errors of the single-time evaluated results are eliminated by collecting probability statistics to the samples.

One example long-term evaluation based on experimental data is shown as table 4b.

TABLE 4b

| Evaluated level | Evaluating index |
|---|---|
| excellent | Proportion of “excellent” > 80% |
| good | Proportion of “good” > 80% |
| Above medium | Proportion of “medium” and above > 80% |
| Below medium | Proportion of “medium” and below > 60% |
| poor | Proportion of “poor” > 80% |

Certainly, the above thresholds, such as 80%, 60%, used for evaluating the levels of the air interface condition of the user in the long-term are merely example values. In practical applications, those with ordinary skill in the art may configure the thresholds of the levels for evaluating the air interface condition of the user in the long-term according to experience or expect. The levels may also be set by those with ordinary skill in the art according to at least one requirement.

It should be noted that, with respect to the evaluation of each layer, other statistical information may be added into the above statistical information items, or may be used to replace the above statistical information items. The above air interface condition quantification values may be configured randomly or may be obtained through other manners. The thresholds used for denoting the levels of the air interface condition and the threshold ranges may also be defined randomly. The definitions of the levels may also be defined randomly. All of these may be adjusted by those with ordinary skill in the art according to changes of the air interface circumstances of the WLAN.

For example, as to the evaluation of the air interface condition of the AP, some statistical information items, such as packet retransmission ratio and interference noise ratio may be added. Suppose that there are 5 quantification values of the air interface condition, including air interface throughput of the AP, packet transmission loss ratio, packet high rate transmission ratio, packet receiving error ratio and packet high rate receiving ratio. It is possible to score each quantification value. The details are as shown in table 5.

TABLE 5

| | | | packet high | | packet high |
|---|---|---|---|---|---|
| | air | packet | rate | packet | rate |
| | interface | transmission | transmission | receiving | receiving |
| score | throughput | loss ratio | ratio | error ratio | ratio |
| 5 | ≧4M | <3% | >90% | <5% | >85% |
| 4 | ≧3M | 3%~5% | 80%~90% | 5%~10% | 70%~85% |
| 3 | <3M | >5% | 60%~80% | 10%~15% | 50%~70% |
| 2 | <2M | >10% | <60% | >15% | <50% |

Then the scores of the quantification values are weighted and added to obtain a weighted sum and the long-term evaluation result may be obtained by comparing the weighted sum with corresponding thresholds.

Suppose the weight of the air interface throughput is 4%, the weight of the packet transmission loss ratio is 18%, the weight of the packet high rate transmission ratio is 30%, the weight of the packet receiving error ratio is 18%, the weight of the packet high rate receiving ratio is 30%, the weighted sum is: the score of the air interface throughput*4%+the score of the packet high rate transmission ratio*30%+the score of the packet transmission loss ratio*18%+the score of the packet high rate receiving ratio*30%+the score of the packet receiving error ratio*18%.

Suppose that the scores of the quantification values of the AP are as follows according to the standards shown in table 5: the score of the air interface throughput is 5, the score of the packet transmission loss ratio is 5, the score of the packet high rate transmission ratio is 5, the score of the packet receiving error ratio is 4, the score of the packet high rate receiving ratio is 5, then the final weighted sum is 5×4%+5×30%+5×18%+5×30%+4×18%=4.82.

Compare 4.82 with a long-term evaluation index. For example, if the weighted sum is larger than 4.5, the long-term evaluated result is “excellent”; if the weighted sum is larger than 3.5 but smaller than or equal to 4.5, the long-term evaluated result is “good”; if the weighted sum is larger than 2.5 but smaller than or equal to 3.5, the long-term evaluated result is “medium”; and if the weighted sum is smaller than 2.5, the long-term evaluated result is “poor”.

Similarly, as to the evaluation of the area and the place, it is also possible to adopt the above weighted evaluation.

In addition, the evaluation of the area and the place may be seen as an evaluation of a set of APs. Therefore, in addition to the above-mentioned evaluation methods, it is also possible to obtain the evaluated result of the area and the place directly according to the evaluated results of the set of APs. Similarly, the evaluated result of the AP may also be obtained according to the evaluated results of the users accessing the AP. This type of evaluation makes the evaluation of an upper layer dependent on the evaluation of a lower layer.

In view of the above, the evaluation manners of the layers may be various and are not restricted to one or several specific manners.

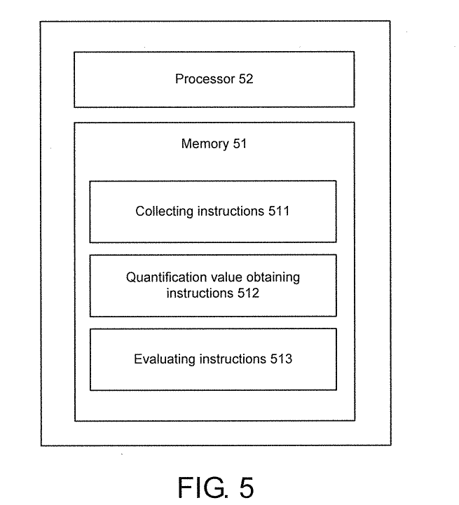

As shown in FIG. 5, an apparatus for evaluating air interface condition includes:

a memory 51; and

a processor 52 in communication with the memory 51, the memory 51 may be computer readable storage media including instructions executable with the processor 52, wherein the memory 51 includes:

collecting instructions 511, may be executed to collect statistical information items that reflect the air interface condition of the WLAN;

quantification value obtaining instructions 512, may be executed to collect statistics according to the statistical information items to obtain quantification values of the air interface condition of a pre-defined area, to obtain quantification values of the air interface condition of each place in the pre-defined area, to obtain quantification values of the air interface condition of each AP in each place, and to obtain quantification values of the air interface condition of each user accessing each AP;

evaluating instructions 513, may be executed to compare the quantification values of the air interface condition of the pre-defined area, the quantification values of the air interface condition of each place, the quantification values of the air interface condition of each AP and the quantification values of the air interface condition of each user with corresponding thresholds, to obtain evaluated results respectively denoting a level of the air interface condition of the pre-defined area, a level of the air interface condition of each place, a level of the air interface condition of each AP and a level of the air interface condition of each user.

Certainly, the evaluated results denoting the levels of the air interface condition of each AP and the air interface condition of each user refer to single-time evaluated results.

If a long-term evaluation is to be performed, the apparatus for evaluating an air interface condition may further include: first integrated evaluating instructions (not shown in FIG. 5) to collect balanced statistics to the evaluated results of the air interface condition of the AP and to obtain a long-term evaluated result of the AP according to the balanced statistics; and

the apparatus for evaluating air interface condition may further include second integrated evaluating instructions (not shown in FIG. 5) to collect balanced statistics to the evaluated results of the air interface condition of the user and to obtain a long-term evaluated result of the user according to the balanced statistics.

In practical applications, the apparatus for evaluating an air interface condition as shown in FIG. 5 may be integrated inside an AC. All the APs in the area report their air interface packets to the ACs that they respectively belong to. All the ACs in the area aggregate the air interface packets or information carried in the air interface packets to the AC where the apparatus for evaluating air interface condition resides. Thus, the apparatus for evaluating air interface condition shown in FIG. 5 is able to collect statistical information items from the information carried in the air interface packets reported by all the APs. Or, the apparatus for evaluating air interface condition shown in FIG. 5 may also be integrated in a network management device. All the APs in the area report air interface packets to the ACs to which they respectively belong. The ACs in the area reports the air interface packets or information carried in the air interface packets to the network management device. Thus, the apparatus for evaluating air interface condition shown in FIG. 5 is able to collect statistical information items from the information carried by the air interface packets reported by all the APs. Or, the apparatus for evaluating air interface condition shown in FIG. 5 may be a device independent from the AC and the network management device. All the APs in the area report air interface packets to the ACs to which they respectively belong. The ACs in the area report the air interface packets or information carried in the air interface packets to the independent apparatus for evaluating air interface condition. Thus, the apparatus for evaluating air interface condition shown in FIG. 5 is able to collect statistical information items from the information carried by the air interface packets reported by all the APs.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for evaluating an air interface condition of a Wireless Local Area Network (WLAN), comprising:
collecting statistical information items that reflect the air interface condition of the WLAN;
collecting statistics according to the statistical information items to obtain quantification values of an air interface condition of a pre-defined area, quantification values of an air interface condition of each place in the pre-defined area, quantification values of an air interface condition of each Access Point (AP) in each place, and quantification values of an air interface condition of each user accessing each AP;
respectively comparing the quantification values of the air interface condition of the pre-defined area, the quantification values of the air interface condition of each place, the quantification values of the air interface condition of each AP and the quantification values of the air interface condition of each user with corresponding thresholds, and obtaining evaluated results respectively denoting a level of the air interface condition of the pre-defined area, a level of the air interface condition of each place, a level of the air interface condition of each AP and a level of the air interface condition of each user.

2. The method of claim 1, wherein the statistical information items are collected within a pre-defined evaluation time period.

3. The method of claim 1, wherein the statistical information items used for collecting statistics to obtain the quantification values of the air interface condition of the pre-defined area comprise: a total air interface throughput of all APs under all Access Controllers (ACs) of the pre-defined area, the number of normal-operating APs under all the ACs of the pre-defined area, the number of users accessing the normal-operating APs under all the ACs of the pre-defined area, and
the quantification values of the air interface condition of the pre-defined area comprise: an average air interface throughput for each AP under all the ACs of the pre-defined area, and an average air interface throughput for each user in the pre-defined area.

4. The method of claim 1, wherein the statistical information items used for collecting statistics to obtain the quantification values of the air interface condition of each place comprise: a total air interface throughput of all APs in the place, the number of normal-operating APs in the place, packet transmission rate statistical data of all the APs in the place and packet receiving rate statistical data of all the APs in the place; and
the quantification values of the air interface condition of the place comprise: an average air interface throughput for each AP in the place, an average packet high rate transmission ratio of the place, and an average packet high rate receiving ratio of the place.

5. The method of claim 2, wherein the statistical information items used for collecting statistics to obtain the quantification values of the air interface condition of the AP within each evaluation time period comprise: an air interface throughput of the AP, packet transmission loss statistical data of the AP, packet transmission rate statistical data of the AP, packet receiving error statistical data of the AP, packet receiving rate statistical data of the AP, and the number of users accessing the AP; and
the quantification values of the air interface condition of the AP obtained within each evaluation time period comprise: an average air interface throughput for each user accessing the AP, a packet transmission loss ratio of the AP, a packet high rate transmission ratio of the AP, a packet receiving error ratio of the AP, and a packet high rate receiving ratio of the AP.

6. The method of claim 5, further comprising: collecting statistics of the evaluated result denoting the air interface condition of the AP obtained within each evaluation time period, and obtaining a long-term evaluated result of the air interface condition of the AP based on the statistics collected.

7. The method of claim 2, wherein the statistical information items used for collecting statistics to obtain the quantification values of the air interface condition of the user within each evaluation time period comprise: an air interface throughput of the user, packet loss statistical data of packets transmitted by the AP to the user, packet transmission rate statistical data of packets transmitted by the AP to the user, packet receiving rate statistical data of packets received by the AP from the user, and a signal to noise ratio of the user; and
the quantification values of the air interface of the user obtained within each evaluation time period comprise: the air interface throughput of the user, a packet loss ratio of packets transmitted by the AP to the user, a packet high rate transmission ratio of packets transmitted by the AP to the user, and a packet high rate receiving ratio of packets received by the AP from the user.

8. The method of claim 7, further comprising:
collecting statistics of the evaluated result denoting the air interface condition of the user obtained within each evaluation time period, and obtaining a long-term evaluated result of the air interface condition of the user based on the statistics collected.

9. An apparatus for evaluating an air interface condition of a Wireless Local Area Network (WLAN), comprising:
a memory; and
a processor in communication with the memory, the memory comprising computer, code executable with the processor, wherein the computer code is:
to collect statistical information items that reflect the air interface condition of the WLAN;
to collect statistics according to the statistical information items to obtain quantification values of the air interface condition of a pre-defined area, to obtain quantification values of the air interface condition of each place in the pre-defined area, to obtain quantification values of the air interface condition of each AP in each place, and to obtain quantification values of the air interface condition of each user accessing each AP;
to compare the quantification values of the air interface condition of the pre-defined area, the quantification values of the air interface condition of each place, the quantification values of the air interface condition of each AP and the quantification values of the air interface condition of each user with corresponding thresholds, to obtain evaluated results respectively denoting a level of the air interface condition of the pre-defined area, a level of the air interface condition of each place, a level of the air interface condition of each AP and a level of the air interface condition of each user.

10. The apparatus of claim 9, wherein the computer code is further to collect the statistical information items periodically within a pre-defined evaluation time period.

11. The apparatus of claim 9, wherein the statistical information items used to obtain the quantification values of the air interface condition of the pre-defined area comprise: total air interface throughput of all APs under all Access Controllers (ACs) of the pre-defined area, the number of normal-operating APs under the AC of the pre-defined area, the number of users accessing the normal-operating APs under the AC of the pre-defined area, and
the quantification values of the air interface condition of the pre-defined area comprise: an average air interface throughput for each AP under the AC of the pre-defined area, and an average air interface throughput for each user in the pre-defined area.

12. The apparatus of claim 9, wherein the statistical information items used to collect statistics to obtain the quantification values of the air interface condition of the place comprise: a total air interface throughput of all APs in the place, the number of normal-operating APs in the place, packet transmission rate statistical data of all the APs in the place, and packet receiving rate statistical data of all the APs in the place; and
the quantification values of the air interface condition of the place comprise: an average air interface throughput for each AP in the place, an average packet high rate transmission ratio of the place, and an average packet high rate receiving ratio of the place.

13. The apparatus of claim 10, wherein the statistical information items used to collect statistics to obtain the quantification values of the air interface condition of the AP within each evaluation time period comprise: an air interface throughput of the AP, packet transmission loss statistical data of the AP, packet transmission rate statistical data of the AP, packet receiving error statistical data of the AP, packet receiving rate statistical data of the AP, and the number of users accessing the AP; and
the quantification values of the air interface condition of the AP obtained within each evaluation time period comprise: an average air interface throughput for each user accessing the AP, a packet transmission loss ratio of the AP, a packet high rate transmission ratio of the AP, a packet receiving error ratio of the AP, and a packet high rate receiving ratio of the AP.

14. The apparatus of claim 13, wherein the computer code is further to:
collect balanced statistics to evaluated results of the air interface condition of the AP and to obtain a long-term evaluated result of the AP according to the balanced statistics.

15. The apparatus of claim 10, wherein the statistical information items used to collect statistics to obtain the quantification values of the air interface condition of the user within each evaluation time period comprise: an air interface throughput of the user, packet loss statistical data of packets transmitted by the AP to the user, packet transmission rate statistical data of packets transmitted by the AP to the user, packet receiving rate statistical data of packets received by the AP from the user, and a signal to noise ratio of the user; and
the quantification values of the air interface of the user obtained within each evaluation time period comprise: the air interface throughput of the user, a packet loss ratio of packets transmitted by the AP to the user, a packet high rate transmission ratio of packets transmitted by the AP to the user, and a packet high rate receiving ratio of packets received by the AP from the user.
